(19) United States
(12) Patent Application Publication
(10) Pub. No.: US 2025/0038631 A1
(43) Pub. Date: Jan. 30, 2025

(54) METHOD FOR PRODUCING A LAMINATED CORE OF AN ELECTRIC MACHINE

(71) Applicant: Robert Bosch GmbH, Stuttgart (DE)

(72) Inventors: Martin Koehne, Asperg (DE); Maxim Smirnov, Dornstetten (DE); Wolfgang Rammaier, Rutesheim (DE)

(21) Appl. No.: 18/717,709

(22) PCT Filed: Nov. 14, 2022
(86) PCT No.: PCT/EP2022/081739

§ 371 Date: Jun. 7, 2024

(30) Foreign Application Priority Data
Dec. 8, 2021 (DE) 10 2021 213 935.3

(51) Int. Cl. H02K 15/10; H02K 1/02; H02K 15/02; H02K 15/12

(52) U.S. Cl. CPC H02K 15/10; H02K 1/02; H02K 15/02; H02K 15/12; H02K 2201/09; H02K 2213/03; H02K 2215/00

(57) ABSTRACT

In a method for producing a laminated core (1) of an electric machine, sheet metal laminations (4, 5), which are based on an iron material, are alloyed by means of heat treatment with an alloy material (16) comprising silicon. Before the heat treatment, aluminum-based foil laminations (6, 7) which comprise foil aluminum oxide layers (8, 9) and are each at least partially coated with the alloy material, are arranged between the sheet metal laminations (4, 5).

### BACKGROUND

The invention relates to a method for producing a laminated core of an electrical machine.

EP 3 511 429 A1 describes a method for producing a laminated core. In this process, sheet metal laminations of the initial laminated core are coated with a foil coating containing a mass fraction of at least 20% aluminum and/or silicon. This initial laminated core is subjected to heat treatment to obtain the laminated core. This makes it possible to obtain a laminated core with a silicon content corresponding to a mass fraction of at least 6.5%.

### SUMMARY

The method according to the invention for producing a laminated core has the advantage that subsequent alloying of sheet metal laminations of the laminated core of an electrical machine and subsequent production of insulation layers on or between the sheet metal laminations of the laminated core is made possible in a cost-effective manner. In this way, low-cost electrical sheet with a low aluminum and silicon content, for example <4.0 mass %, can be alloyed to a higher aluminum and silicon content of, for example, 4.0-8.5 mass % by heat treatment, at least in the region close to the surface.

In addition, the electrical resistance of the sheet metal laminations of the laminated core can be advantageously increased without excessively impairing the soft magnetic properties. This improves the efficiency of the electrical machine.

According to the invention, in a first step, foil laminations are provided which each have a carrier foil made of aluminum and a natural or produced insulator layer formed on the carrier foil, for example a foil aluminum oxide layer, and each have a foil coating on at least one side of the foil laminations. The foil coating comprises an alloy material, an adhesive bonding agent to adhere the alloy material to the foil laminations and, in particular, aluminum oxide in powder form.

Furthermore, in a second step, sheet metal laminations of the laminated core are provided which are, in particular, electrically uninsulated, which is a difference to a conventional embodiment in which these are electrically insulated. If the sheet metal laminations have paint insulation, this should be removed, as otherwise diffusion could be impeded and carbon from the paint layer could enter the sheet metal undesirably.

In a third step, sheet metal laminations and foil laminations are stacked alternately in such a way that at least one foil lamination is positioned between adjacent sheet metal laminations.

Furthermore, in a fourth step, the stack of sheet metal laminations and foil laminations is heated, for example heat-treated, in such a way that
the aluminum diffuses from the carrier foils of the foil laminations with a certain depth into the metal of the respective adjacent sheet metal laminations with dissolution of the carrier foil and that the alloy material diffuses from the foil coating of the foil laminations with a certain depth into the metal of the adjacent sheet metal lamination with formation of an alloyed-up region, and
the aluminum oxide remains from the foil aluminum oxide layer of the foil laminations or from the foil coating of the foil laminations with formation of an insulating layer between the sheet metal laminations.

It is advantageous if the shape and/or the surface of the foil laminations correspond to the shape and/or the surface of the sheet metal laminations. This results in a particularly advantageous structure in terms of the geometry of the individual layers.

It is advantageous if the aluminum-based foil laminations are or will be separated from an aluminum foil which has the at least one foil aluminum oxide layer on at least one side and/or which is at least partially coated with the alloy material on at least one side. In particular, such an aluminum foil can be coated and, for example, pre-rolled in an upstream production process. It is also advantageous that the foil coating is not too thick. This enables advantageous adhesion and unrolling.

It is also advantageous if the alloy material is at least partially applied to at least one side of the foil laminations by means of an adhesive bonding agent, in particular a paste and/or by means of polysaccharides, in particular xanthan gum. The alloy material is preferably in powder form. This allows the powdered alloy material to be securely bonded to the aluminum foil. A silicon powder and, if necessary, an additional aluminum oxide powder can be mixed with water and xanthan gum, for example. This mixture can then be applied to at least one side of the aluminum foil using a compressed air spray gun, for example. During subsequent drying, the water evaporates and the xanthan gum remaining in the mixture ensures that the powder or powders adhere well. This can be done for one or both top sides of the aluminum foil.

It is advantageous if at least one of the foil laminations is at least partially arranged between adjacent sheet metal laminations. It is advantageous for an alloy of sheet metal laminations if the mass fraction of silicon is significantly increased, but the mass fraction of silicon and aluminum is not too high. This means that it is usually advantageous if the amount of aluminum (in metallic form) is not too large compared to the amount of silicon contained in the foil coating. If foils coated on both sides are inserted between adjacent sheet metal laminations, the amount of silicon can be easily increased without the foil coating becoming too thick. This ensures that the foil coating adheres reliably to both sides of the aluminum foil. Another advantage is that the sum of the layer thicknesses of the foil aluminum oxide layers can be easily doubled. In particular, this allows an insulating layer of aluminum oxide to form in the produced laminated core between the electrical sheets during heat treatment. Furthermore, the mass fraction of aluminum can be limited, in particular to reduce or completely prevent an increase in magnetostriction with increasing aluminum content.

It is advantageous if at least two of the foil laminations are at least partially arranged between adjacent sheet metal laminations. It is advantageous for an alloy of sheet metal laminations if the mass fraction of silicon is significantly increased, but the mass fraction of silicon and aluminum is not too high. This means that it is usually advantageous if the amount of aluminum (in metallic form) is not too large compared to the amount of silicon contained in the foil coating. If several foil laminations are inserted between neighboring sheet metal laminations, the amount of silicon can be easily increased without increasing the thickness of the foil coating too much. In particular, this ensures that the foil coating adheres reliably to the relevant side of the aluminum foil. Another advantage is that the sum of the layer thicknesses of the foil aluminum oxide layers can be easily increased. This prevents a foil aluminum oxide layer from being partially rubbed off during handling, for example, or from falling off in parts in any other way. In this way, an insulating layer of aluminum oxide can be formed in the produced laminated core. Furthermore, the mass fraction of aluminum can be limited, in particular to reduce or completely prevent an increase in magnetostriction with increasing aluminum content. This can be achieved, for example, if two foil laminations are used instead of a single foil lamination, wherein the two foil laminations have the same total thickness as the single foil lamination. For example, instead of one foil lamination with a thickness of 10 μm, two foil laminations with a thickness of 5 μm each can be used, each with a foil aluminum oxide layer, which can double the total thickness of the foil aluminum oxide layers.

It is also advantageous if a thickness of the foil laminations and the alloy material applied to the foil laminations and possibly the electrically insulating solid are selected such that after heat treatment at least on a part of the surface of the sheet metal laminations, at least near the surface, a mass fraction of silicon is at least approximately 6.5% and a mass fraction of silicon and aluminum is not greater than 8.5%. In particular, this allows a vanishing magnetostriction to be achieved, resulting in low pressure sensitivity and high magnetic permeability. The near-surface alloy can, for example, affect an edge region or an edge zone of around 500 μm. This is advantageous because eddy currents also occur close to the surface at high frequencies. A core region can then be realized in an advantageous way without or with a reduced mass fraction of silicon and/or aluminum, so that the material of the electrical sheets is tough there and thus mechanically well resilient. Preferably, the mass fraction of silicon and aluminum is not greater than 8.5%. The base material of the sheet metal laminations can, for example, have a silicon content of around 3% by mass. The mass fraction of silicon is then further increased by heat treatment, resulting in a preferred mass fraction of 6.5% for silicon.

In a further possible embodiment, it is advantageous that a thickness of the foil laminations and the alloy material applied to the foil laminations and possibly the electrically insulating solid material are selected such that after the heat treatment at least on a part of the surface of the sheet metal laminations, at least near the surface, a mass fraction of the silicon is between about 4% and about 5% and a mass fraction of silicon and aluminum is not greater than about 8.5%. This design enables the use of a cost-effective material for the sheet metal laminations. In particular, sheet metal laminations with a material that does not contain a significant proportion of silicon can then be used. The mass fraction of silicon can then be increased by heat treatment.

Preferably, the increase in the mass fraction of silicon does not extend into the core region of the sheet metal laminations, as the heat treatment required for this would generally also change the grain size. This prevents a change in grain size.

It is advantageous if the foil laminations have a thickness of around 5 μm to around 10 μm and are preferably as thin as possible. For example, a foil aluminum oxide layer of 1 μm can be provided. A desired number of foil laminations can be inserted between the sheet metal laminations. This enables advantageous handling, as at least partial detachment of the foil aluminum oxide layer can be reliably avoided. One advantage of the foil aluminum oxide layer of the aluminum foil is that it forms a foil aluminum oxide layer between the electrical sheets as an electrically insulating layer during heat treatment. With powder, there is a higher risk for areas that are not sufficiently electrically insulated. Furthermore, this design allows the foil coating to be relatively thin without the mass fraction of aluminum in the sheet metal laminations becoming undesirably high after heat treatment.

It is also advantageous if a heat treatment of the sheet metal laminations with the coated foil laminations arranged in between is carried out in a range from about 150° C. to 500° C. for about one to about two hours prior to the heat treatment for alloying. This allows an adhesive bonding agent or a polysaccharide to be reliably degraded. The heat treatment can be carried out under hydrogen. At 400° C., for example, xanthan gum is decomposed into water, carbon monoxide, carbon dioxide and methane and thus removed. The silicon and aluminum can then be diffused into the sheet metal laminations by heat treatment at 1250° C., for example. When the silicon and aluminum are completely diffused, the aluminum oxide remains as an electrically insulating layer between the sheet metal laminations.

In a laminated core for a rotor, it is advantageous if the foil laminations are partially coated with the alloy material in such a way that the alloy material is provided more on the radially outer parts of the foil laminations than on the radially inner parts of the foil laminations. In particular, this makes it possible to achieve a reduced alloy near the corrugation so that the material remains tough there. In contrast, a higher alloy can be achieved away from the shaft, so that the specific electrical resistance is increased and thus remagnetization losses are reduced.

It is advantageous in a corresponding manner that in a laminated core for a stator, the foil laminations are partially coated with the alloy material in such a way that the alloy material is provided closer to the radially inner parts of the foil laminations than to the radially outer parts of the foil laminations.

### BRIEF DESCRIPTION OF THE DRAWINGS

Preferred exemplary embodiments of the invention are explained in more detail in the following description with reference to the accompanying drawings in which corresponding elements are provided with the same reference signs. In the following:

FIG. 1 shows the structure of an aluminum foil according to an exemplary embodiment in a schematic sectional view;

FIG. 2 shows the aluminum foil shown in FIG. 1 with a foil coating according to the exemplary embodiment;

FIG. 3 is a schematic representation of the aluminum foil shown in FIG. 2 in a partially rolled-up state;

FIG. 4 shows the structure of a laminated core according to an exemplary embodiment during the production in a schematic sectional view, the left part representing the section of the laminated core before heat treatment and the right part representing the section of the laminated core after heat treatment, wherein the section marked IV in FIG. 4A is shown;

FIG. 4A is a schematic representation of an entire laminated core;

FIG. 5 shows the structure shown in FIG. 1 during the production according to a modified design before heat treatment, wherein a section of the entire laminated core is shown as in FIG. 4;

FIG. 6 is a top view of a coated foil lamination for the laminated core shown in FIG. 1 and FIG. 2 according to a possible embodiment;

FIG. 7 shows the laminated core shown in FIG. 1 and FIG. 2 in the produced state after heat treatment;

FIG. 8A is a phase diagram illustrating the invention, wherein a diagram for an austenite stabilizer is shown;

FIG. 8B is a phase diagram illustrating the invention, wherein a diagram for a eutectoid former is shown; and

FIG. 8C is a phase diagram illustrating the invention, wherein a diagram for a ferrite former is shown.

### DETAILED DESCRIPTION

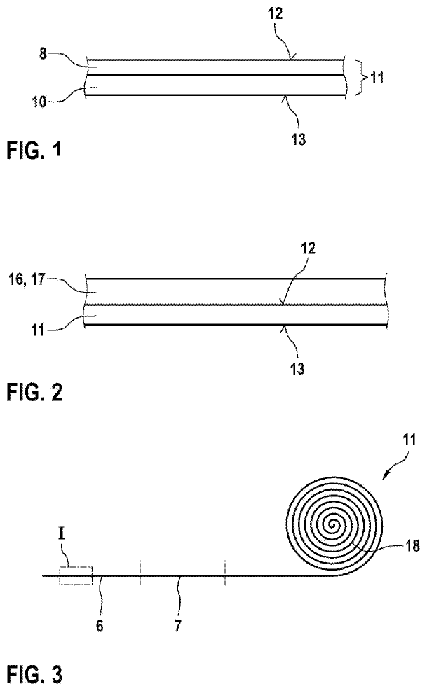

FIG. 1 shows the structure of an aluminum foil 11 according to an exemplary embodiment in an excerpt, schematic sectional view. The aluminum foil 11 has a foil aluminum oxide layer 8. Furthermore, the aluminum foil 11 has a carrier foil 10 that is not oxidized and therefore consists of pure aluminum.

FIG. 2 shows the aluminum foil 11 shown in FIG. 1 with a foil coating 17 according to the exemplary embodiment. The foil coating 17 is formed from an alloy material 16 and is applied to one of the sides 12, 13. The alloy material 16 comprises silicon and preferably consists at least essentially of silicon. The foil coating 17 can have other components. The thinnest possible design of the aluminum foil 11 with the thickest possible foil coating 17 with alloying elements, such as silicon, is advantageous.

FIG. 3 shows a schematic representation of the aluminum foil 11 shown in FIG. 2 in a partially rolled-up state. The foil coating 17 is not shown here to simplify the illustration. Foil laminations 6, 7 are separated from the aluminum foil 11, which are then each coated with the foil coating 17.

The aluminum foil 11 can then be supplied in such a way that a foil aluminum oxide layer 8 is provided on one or both sides 12, 13 of the aluminum foil 11. Thus, depending on the configuration, a foil aluminum oxide layer 8, 9 may be present on only one of the sides 12, 13 or on both sides 12, 13. The aluminum foil 11 can be rolled up on a roll 18, which is illustrated schematically.

Preferably, there is a foil aluminum oxide layer 8 on only one of the sides 12, 13 and the foil coating 17, which is based on silicon, on only one of the sides 12, 13.

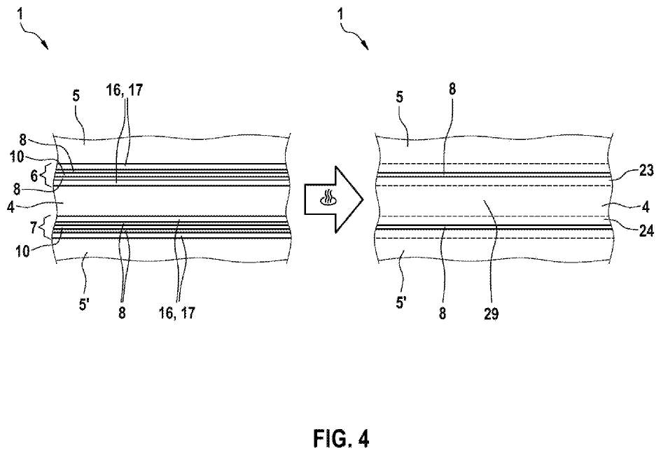

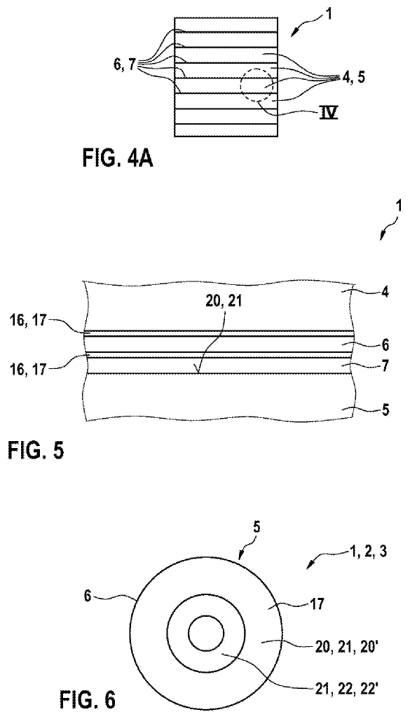

FIG. 4 shows a schematic sectional view of the structure of a laminated core 1 according to an exemplary embodiment during the production.

Here, 4 shows the section of the entire laminated core 1 shown in FIG. 4A with IV.

The laminated core 1 can be used in particular for a rotor 2 (FIG. 6) or a stator of an electrical machine 3. Such a rotor 2 can then have several such laminated cores 1. In particular, the laminated core 1 is suitable for an electric machine 3, which serves as an electric drive motor 3 for motor vehicles.

According to the invention, the following method steps are carried out to produce the laminated core 1:

In a first step, foil laminations 6, 7, 10, 11 are provided, each having a carrier foil 10 made of aluminum, i.e., an aluminum foil, and a natural or produced insulator layer 8 formed on the carrier foil 10, in particular a foil aluminum oxide layer 8, and each having a foil coating 17 on at least one side 12, 13. The foil coating 17 comprises an alloy material 16, for example silicon, an adhesive bonding agent and, in particular, additionally aluminum oxide in powder form.

In a subsequent second step, sheet metal laminations 4, 5 of the laminated core 1 are provided, which are in particular electrically uninsulated.

In a subsequent third step, sheet metal laminations 4, 5 and foil laminations 6, 7, 11 are alternately stacked in such a way that at least one foil lamination 6, 7, 11 lies between adjacent sheet metal laminations 4, 5.

In a subsequent fourth step, the stack of sheet metal laminations 4, 5 and foil laminations 6, 7, 11 is heated, in particular heat-treated, in such a way that
a) the aluminum diffuses from the carrier foils 10 of the foil laminations 6, 7, 10, 11 with a certain depth into the metal of the respective adjacent sheet metal lamination 4, 5 with dissolution of the carrier foil 10 and that the alloy material 16 diffuses from the foil coating 17 of the foil laminations 6, 7, 11 with a certain depth 25, 26 into the metal of the adjacent sheet metal lamination 4, 5 with formation of an alloyed-up region 23, 24, and
b) the aluminum oxide (AI2O3) from the foil aluminum oxide layer 8 or from the foil coating 17 of the foil laminations 6, 7, 11 remains between the sheet metal laminations 4, 5, forming an insulating layer 27.

Heating in the fourth step can take place, for example, by radiation and/or convection, inductively or by current flow through the sheet metal laminations 4, 5.

The laminated core 1 has sheet metal laminations 4, 5, 5′, which are based on an iron material.

During the production, at least one foil lamination 6, 7 is arranged between each of the adjacent sheet metal laminations 4, 5, 5′. In the exemplary embodiment shown in FIG. 1, one foil lamination 6 is arranged between the sheet metal laminations 4, 5 and one foil lamination 7 is arranged between the sheet metal laminations 4, 5′.

Preferably an aluminum foil 11 of an entire roll or coil is coated and rolled up again. During the production of the laminated cores 1, which is carried out by alternately stacking sheet metal laminations (electrical sheet) 4, 5 and aluminum foil, the foil laminations 6, 7 are cut from the aluminum foil roll 11 and placed between the sheet metal laminations 4, 5, 5′.

In the embodiment shown, the foil lamination 6 has a foil aluminum oxide layer 8 on both sides 12, 13. Furthermore, the foil coating 17 is applied to both sides 12, 13 of the foil lamination 6.

After heat treatment, the state shown in FIG. 4 on the right is achieved. The volume of the sheet metal laminations 4, 5, 5′ has increased in each case, as the silicon and the aluminum have diffused into alloyed zones or regions 23, 24 of the sheet metal laminations 4, 5. This allows the aluminum to form a eutectic with the silicon, which facilitates diffusion. The aluminum oxide 8 remains between the layers 4, 5, 5′.

FIG. 5 shows the structure shown in FIG. 1 during the production according to a modified design, wherein a section of the entire laminated core is shown as in FIG. 4. In this embodiment, foil laminations 6, 7 can be separated from the aluminum foil 11 and several, for example two foil laminations 6, 7, can be arranged between adjacent sheet metal laminations 4, 5. This has the advantage that more aluminum oxide and/or alloy material 16 can be introduced between adjacent sheet metal laminations 4, 5 if the aluminum foil 11 used then has a layer 10 of pure aluminum that is half as thick, for example. The introduction of correspondingly more aluminum oxide and/or alloy material 16 can thus be achieved without impairing handling too much. To simplify the illustration, the layer structure of the foil laminations 6, 7 is not shown in FIG. 5. This results in a corresponding manner from the design described with reference to FIG. 1. The foil laminations 6, 7 are preferably much thinner than the foil coating 17 with the alloy material 16.

The foil coating 17 can have an adhesive bonding agent and/or a polysaccharide, in particular xanthan gum, with which the alloy material 16 is applied to the upper side 14 of the aluminum foil 11 and thus to the foil laminations 6, 7. In a modified embodiment, however, the alloy material 16 can also be applied as an aqueous suspension. However, application by means of an adhesive bonding agent and/or a polysaccharide has the advantage that a more uniform and constant application to sheet metal laminations 4, 5, which have generally already been punched out, is possible even with complex geometries. Another advantage is that the powdered alloy material 16 does not fall off the aluminum foil 11 and the foil laminations 6, 7 after drying.

The adhesive bonding agent or polysaccharide can be removed by a heat treatment that precedes the heat treatment for alloying. This heat treatment can be carried out in a hydrogen atmosphere in a range of around 150° C. to 500° C. for around one to two hours.

Further variations are conceivable. For example, more than two foil laminations 6, 7 can also be arranged between adjacent sheet metal laminations 4, 5. It is also conceivable that variations in the structure can be realized within the laminated core 1. For example, it is not necessarily the case that foil laminations 6, 7 are always provided between adjacent sheet metal laminations or that the same number of foil laminations 6, 7 are always provided between adjacent sheet metal laminations. Preferably, however, a uniform structure of the laminated core is realized during production.

A thickness of the aluminum foil 11 and thus of the foil laminations 6, 7 as well as the design and composition of the foil coating 17, in particular of the alloy material 16, are selected such that after the heat treatment at least on a part 20 of the surface 21 of the sheet metal lamination 5, at least near the surface, a mass fraction of the silicon is at least approximately 6.5% and a mass fraction of silicon and aluminum is not greater than 8.5%. This results in the same way for the sheet metal lamination 4. In a modified embodiment, a specification can be selected in which the mass fraction of silicon is between about 4% and about 5% and a mass fraction of silicon and aluminum is not greater than about 8.5%. The alloying of the sheet metal lamination 5 can take place on the entire surface 21 of the sheet metal lamination 5. However, the alloy can also be applied to only a part 20 of the surface 21 of the sheet metal lamination 5, as described below with reference to FIG. 6.

FIG. 6 shows a top view of a coated foil lamination 6, which is arranged on the sheet metal lamination 5, for the laminated core 1 shown in FIG. 1 and FIG. 2 corresponding to a possible configuration for a rotor 2. Here, part 20 is a radially external part 20 in which eddy currents can occur during operation, at least in principle. A higher alloy is therefore particularly useful here in order to prevent losses due to eddy currents. Another part 22 is a radially inner part 22 of the surface 21. Parts 20, 22 of the sheet metal lamination 5 correspond to parts 20′, 22′ of the foil lamination 6. The foil lamination 6 can now be provided with the foil coating 17 in such a way that the foil coating 17 is only located on the part 20′ of the foil lamination 6. This means that after production, a higher alloy is achieved in part 20 of the sheet metal lamination 5 than in the other part 22 of the sheet metal lamination 5. In particular, this allows the iron material in part 22, with which the sheet metal lamination 5 is pressed onto a shaft, for example, to have a higher mechanical load-bearing capacity.

This ensures that no gap is formed in the part 22, as the silicon in the part 20 does not disappear with its volume after diffusing into the iron of the electrical sheet 5, but the electrical sheet 5 increases in thickness accordingly. To compensate for this, an inert powder, such as an aluminum oxide powder, can be used in part 21, for example.

The design for a rotor 2 described in FIG. 6 can be realized in a correspondingly reversed manner on a laminated core 1, which is used for a stator.

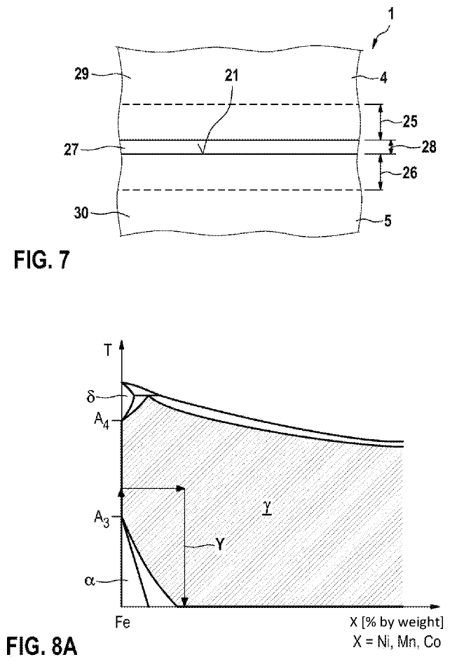

FIG. 7 shows the laminated core 1 shown in FIG. 5 in its produced state. The laminated core 1 shown on the right-hand side in FIG. 4 is produced in the same way. The heat treatment used for alloying, which can take place, for example, in a range of 950° C. to 1250° C., preferably at 1000° C. to 1100° C., over a period of 10 to 30 minutes, for example, results in diffusion of silicon and aluminum into the sheet metal laminations 4, 5. Diffusion is preferably achieved close to the surface, resulting in average penetration depths 25, 26 for the sheet metal laminations 4, 5 that are less than half the thickness of the sheet metal laminations 4, 5. An aluminum oxide layer 27 remains between the sheet metal laminations 4, 5 as insulator 27, wherein a thickness 28 of the aluminum oxide can be specified. Cores 29, 30 of the sheet metal laminations 4, 5 are then less alloyed or largely unalloyed in relation to the alloy material 16.

In one possible embodiment, the aluminum foil 11 can have a thickness of around 5 μm to around 10 μm. However, an aluminum foil 11 that is anodically oxidized on both sides, for example, can also have a foil thickness of 0.03 mm and an oxide layer thickness of 5 to 6 μm in a modified embodiment. The alloy material 16 in the form of a silicon powder with an average grain size of 1 to 5 μm, for example, is particularly suitable for such a foil thickness of 0.03 mm. With a foil thickness of 5 μm, for example, a silicon powder with an average grain size of 1 to 5 μm and, if necessary, an aluminum oxide powder with an average grain size of 0.5 μm can also be used. The aluminum foil 11 can then, for example, have a foil aluminum oxide layer with a thickness of 1 μm and a metallic aluminum layer of 4 to 5 μm.

In a modified embodiment, the foil aluminum oxide layer of the aluminum foil 11 and thus on the foil laminations 6, 7 can also be omitted if aluminum oxide is applied to the aluminum foil 11 via the foil coating 17 in addition to the alloy material 16. The aluminum oxide can be an aluminum oxide powder. In principle, an aluminum foil 11 with at least one foil aluminum oxide layer 8, 9 and additionally a foil coating 17 comprising an aluminum oxide can also be used.

Other electrically insulating solids, which are preferably used as electrically insulating powders, can also serve as an electrically insulating component of the foil coating 17 if they are stable, in particular up to 1250° C. in a hydrogen atmosphere, and do not melt. In a hydrogen atmosphere, a significant reduction of aluminum oxide by a maximum mass fraction of 20% only occurs from 1300° C. At a heat treatment temperature of 1250° C., a maximum of 7% of the aluminum oxide is reduced. Silicon oxide (SiO2) and mullite (AI(4+2x)Si(2-2x)O(10-x) with x=0.17 to 0.59) are also stable in a strongly reducing hydrogen atmosphere up to 1250° C. and do not melt. Preferably, oxides of aluminum and silicon are used to form the insulator 27.

The foil laminations 6, 7 can be punched out of the aluminum foil 11 to the same shape as the sheet metal laminations 4, 5 before stacking to form the laminated core 1. However, unpunched foil laminations 6, 7 can also be stacked between the sheet metal laminations 4, 5. The excess foil can then be removed after stacking. It is also possible that the excess foil is not removed and that the excess foil drips off during heat treatment.

In the produced state, for example, the aluminum oxide layer 27 serving as an insulator still has at least some of the fine channels perpendicular to the layer plane that are typical of an oxide layer of anodically oxidized aluminum. Furthermore, a layer structure of the aluminum oxide layer 27 can consist of several thin partial layers.

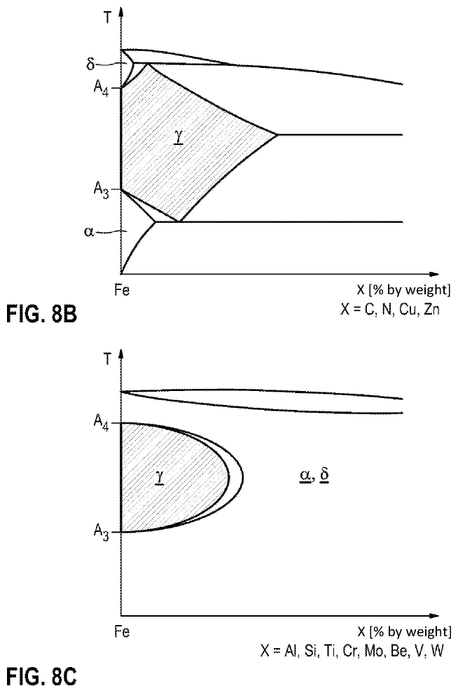

FIGS. 8A, 8B and 8C illustrate the influence of suitable alloying elements X on the size of the respective austenite region in the respective phase diagram of FeX. The concentration of the respective alloying element X in % by weight is shown on the x-axis, while the temperature T is shown on the y-axis.

FIG. 8A shows a phase diagram illustrating the invention, wherein a diagram for an austenite stabilizer is shown. Due to manganese as an austenite stabilizer, the austenite phase (gamma), as shown in the outlined phase diagram, becomes stable with increasing concentration of manganese at ever lower temperatures. The lower temperature limit shown in the diagram is room temperature.

FIG. 8A shows an exemplary process according to the invention along a line Y, which illustrates the effect of austenite stabilization during heat treatment. By diffusing the austenite stabilizer into the respective sheet metal laminations 4,5, the austenite of the heated sheet metal laminations 4,5 is stabilized in such a way that when the sheet metal laminations 4,5 cools down, the austenite is not converted back into ferrite according to the phase diagram.

FIG. 8B shows a phase diagram illustrating the invention, wherein a diagram for a eutectoid former is shown.

Due to copper as a eutectoid former, the austenite phase, as shown in the outlined phase diagram, becomes stable with increasing concentration of copper at lower temperatures. However, stability down to room temperature cannot be achieved. Rather, a minimum temperature at which the austenite phase is still stable occurs at a certain copper concentration. This area, in which austenite is stable even at low temperatures well below A3, enables the austenite to be virtually frozen during cooling and thus preserved during further cooling to room temperature. The temperature up to which the austenite phase is stable then increases as the concentration of copper continues to rise. This makes it increasingly difficult to virtually freeze the austenite during cooling and ultimately this is no longer possible. A further increase in the copper concentration leads to a concentration above which the formation of an austenite phase in the iron is no longer possible.

FIG. 8C shows a phase diagram illustrating the invention, wherein a diagram for a ferrite former is shown.

Ferrite formers such as silicon or aluminum make ferrite (alpha) the stable phase at room temperature, as shown in the sketched phase diagram. This means that the austenite is only stable if there is a low concentration of the ferrite former and a high temperature at the same time. This is why austenite cannot freeze during cooling, as it transforms into ferrite when the temperature is still high.

The invention is not limited to the exemplary embodiments described.

1. A method for producing a laminated core, having the following method steps:
providing foil laminations (6, 7, 10, 11) which each have a carrier foil (10) of aluminum and a natural or produced foil aluminum oxide layer (8) and each have on at least one side (12, 13) a foil coating (17) which comprises an alloy material (16), an adhesive bonding agent and additionally aluminum oxide in powder form;
providing sheet metal laminations (4, 5) of the laminated core (1),
alternate stacking of sheet metal laminations (4, 5) and foil laminations (6, 7, 11) in such a way that at least one foil lamination (6, 7, 11) is located between adjacent sheet metal laminations (4, 5);
heating of the stack of sheet metal laminations (4, 5) and foil laminations (6, 7, 11) in such a way that
a) the aluminum diffuses from the carrier foils (10) of the foil laminations (6, 7, 10, 11) into the metal of the respective adjacent sheet metal laminations (4, 5) with dissolution of the carrier foil (10) and that the alloy material (16) diffuses from the foil coating (17) of the foil laminations (6, 7, 11) with a certain depth (25, 26) into the metal of the adjacent sheet metal laminations (4, 5) with formation of an alloyed-up region (23, 24), and
b) the aluminum oxide from the foil-aluminum oxide layer (8) or from the foil coating (17) of the foil laminations (6, 7, 11) remains between the sheet metal laminations (4, 5), forming an insulating layer (27).

2. The method according to claim 1, wherein the shape and/or the surface of the foil laminations (6, 7, 11) correspond to the shape and/or the surface of the sheet metal laminations (4, 5).

3. The method according to claim 1, wherein,
the aluminum-based foil laminations (6, 7, 10, 11) are or will be separated from an aluminum foil (11) which has the at least one foil aluminum oxide layer (8, 9) on at least one side and/or which is or will be at least partially coated with the alloy material (16) on at least one upper side (14, 15).

4. The method according to claim 3, wherein the alloy material (16) is or is applied at least partially to the at least one upper side (14, 15) of the foil laminations (6, 7, 10, 11) by means of the adhesive bonding agent.

5. The method according to claim 1, wherein,
at least two of the foil laminations (6, 7, 10, 11) are at least partially arranged between adjacent sheet metal laminations (4, 5).

6. The method according to claim 1, wherein,
a thickness of the foil laminations (6, 7, 10, 11) and the alloy material (16) applied to the foil laminations (6, 7, 10, 11) and, if appropriate, the electrically insulating solid material are selected such that, after the heat treatment, at least on a part (20) of the surface (21) of the sheet metal laminations (4, 5), at least near the surface, a mass fraction of the silicon is at least approximately 6.5% and a mass fraction of silicon and aluminum is not greater than approximately 8.5% or, at least near the surface, a mass fraction of the silicon is between approximately 4% and approximately 5% and a mass fraction of silicon and aluminum is not greater than approximately 8.5%.

7. The method according to claim 1, wherein,
the foil laminations (6, 7, 10, 11) have a thickness of about 5 μm to about 10 μm.

8. The method according to claim 1, wherein a heat treatment of the sheet metal laminations (4, 5) with the coated foil laminations (6, 7, 10, 11) arranged therebetween, preceding the heat treatment for alloying, is carried out in a range from about 150° C. to 500° C. over one to about two hours.

9. The method according to claim 1, wherein,
in a laminated core for a rotor, the foil laminations (6, 7, 10, 11) are partially coated with the alloy material (16) in such a way that the alloy material is provided closer to the radially outer parts (20′) of the foil laminations (6, 7, 10, 11) than to the radially inner parts (22′) of the foil laminations (6, 7, 10, 11).

10. The method according to claim 1, wherein,
in a laminated core for a stator, the foil laminations (6, 7, 10, 11) are partially coated with the alloy material (16) in such a way that the alloy material is provided closer to the radially inner parts (20′) of the foil laminations (6, 7, 10, 11) than to the radially outer parts (22′) of the foil laminations (6, 7, 10, 11).

11. The method according to claim 1, wherein the alloy material (16) is silicon.

12. The method according to claim 1, wherein the sheet metal laminations (4, 5) are electrically uninsulated.

13. The method according to claim 1, wherein the heating is a heat treatment.

14. The method according to claim 4, wherein the adhesive bonding agent is a paste.

15. The method according to claim 3, wherein the alloy material (16) is or is applied at least partially to the at least one upper side (14, 15) of the foil laminations (6, 7, 10, 11) by means of a polysaccharide.

16. The method according to claim 15, wherein the polysaccharide is a xanthan gum.
